(19) United States
(12) Patent Application Publication
(10) Pub. No.: US 2013/0298005 A1
(43) Pub. Date: Nov. 7, 2013

(54) Drawing HTML Elements

(71) Applicants: John C. Mayhew, San Francisco, CA (US); Anthony C. Mowatt, Emeryville, CA (US); Valerio Virgillito, San Mateo, CA (US)

(72) Inventors: John C. Mayhew, San Francisco, CA (US); Anthony C. Mowatt, Emeryville, CA (US); Valerio Virgillito, San Mateo, CA (US)

(73) Assignee: Motorola Mobility, Inc., Libertyville, IL (US)

(21) Appl. No.: 13/464,012

(22) Filed: May 4, 2012

(51) Int. Cl. G06F 17/00

(52) U.S. Cl. 715/234

(57) ABSTRACT

In embodiments of drawing HTML elements, an HTML drawing application (108) can enable, via a drawing area interface (112), display of an HTML page (402) and one or more HTML elements in the HTML page. The HTML drawing application (108) can then receive a selection of an HTML element (404) in the HTML page (402), and initiate display of visual feedback (410) on a drawing surface (116) that overlays the HTML page (402) to indicate that the selected HTML element (404) is selected. In other embodiments, the HTML drawing application (108) can initiate display of visual feedback (508) on the drawing surface (116) that overlays an HTML page (502) to indicate that an HTML element (504) can be edited. In some embodiments, the drawing surface (116) is an HTML5 canvas element.

### BACKGROUND

Conventional HTML creation tools allow a user to create HTML elements by typing directly into the HTML code, or by inserting the HTML elements visually based on an existing caret positioned in the HTML page. Further, once an HTML element is placed in the HTML page, the HTML element is then manually styled via cascading style sheets (CSS) classes or styles to further refine the positioning and size of the HTML element. In addition, typical HTML creation tools do not show the user visual feedback for HTML element drawing, selection, or manipulation.

### BRIEF DESCRIPTION OF THE DRAWINGS

Embodiments of drawing HTML elements are described with reference to the following Figures. The same numbers may be used throughout to reference like features and components that are shown in the Figures:

FIG. 1 illustrates an example system in which embodiments of drawing HTML elements can be implemented.

FIG. 2 illustrates examples of drawing interfaces in accordance with one or more embodiments of drawing HTML elements.

FIG. 3 illustrates additional examples of drawing interfaces in accordance with one or more embodiments of drawing HTML elements.

FIG. 4 illustrates additional examples of drawing interfaces in accordance with one or more embodiments of drawing HTML elements.

FIG. 5 illustrates additional examples of drawing interfaces in accordance with one or more embodiments of drawing HTML elements.

FIG. 6 illustrates example method(s) of drawing HTML elements in accordance with one or more embodiments.

FIG. 7 illustrates additional example method(s) of drawing HTML elements in accordance with one or more embodiments.

FIG. 8 illustrates various components of an example electronic device that can implement embodiments of drawing HTML elements.

### DETAILED DESCRIPTION

In embodiments of drawing HTML elements, an HTML drawing application can receive, via a drawing area interface, drawing-input to specify a size and a location of an HTML element to be created in an HTML page. The HTML drawing application can then initiate display of visual feedback on a drawing surface that overlays the HTML page in the drawing area interface as the drawing-input is received, and create the HTML element in the HTML page based on the size and the location specified by the drawing-input. In some embodiments, the drawing surface is an HTML5 canvas element.

In other embodiments, an HTML drawing application can receive, via a drawing area interface, drawing-input to create an HTML element inside an existing HTML element in an HTML page. The HTML drawing application can then initiate display of visual feedback on a drawing surface that overlays the HTML page in the user interface as the drawing-input is received. In some embodiments, the drawing surface is an HTML5 canvas element. The HTML drawing application can determine a position of the HTML element relative to the existing HTML element based on the drawing-input, and create the HTML element inside the existing HTML element in the HTML page based on the position of the HTML element relative to the existing HTML element.

In other embodiments, an HTML drawing application can enable, via a drawing area interface, display of an HTML page and one or more HTML elements in the HTML page. The HTML drawing application can then receive a selection of an HTML element in the HTML page, and initiate display of visual feedback on a drawing surface that overlays the HTML page to indicate that the selected HTML element is selected. In other embodiments, the HTML drawing application can enable, via a drawing area interface, display of an HTML page and an HTML element in the HTML page, and initiate display of visual feedback on a drawing surface that overlays the HTML page to indicate that the HTML element can be edited.

While features and concepts of drawing HTML elements can be implemented in any number of different devices, systems, and/or configurations, embodiments of drawing HTML elements are described in the context of the following example devices, systems, and methods.

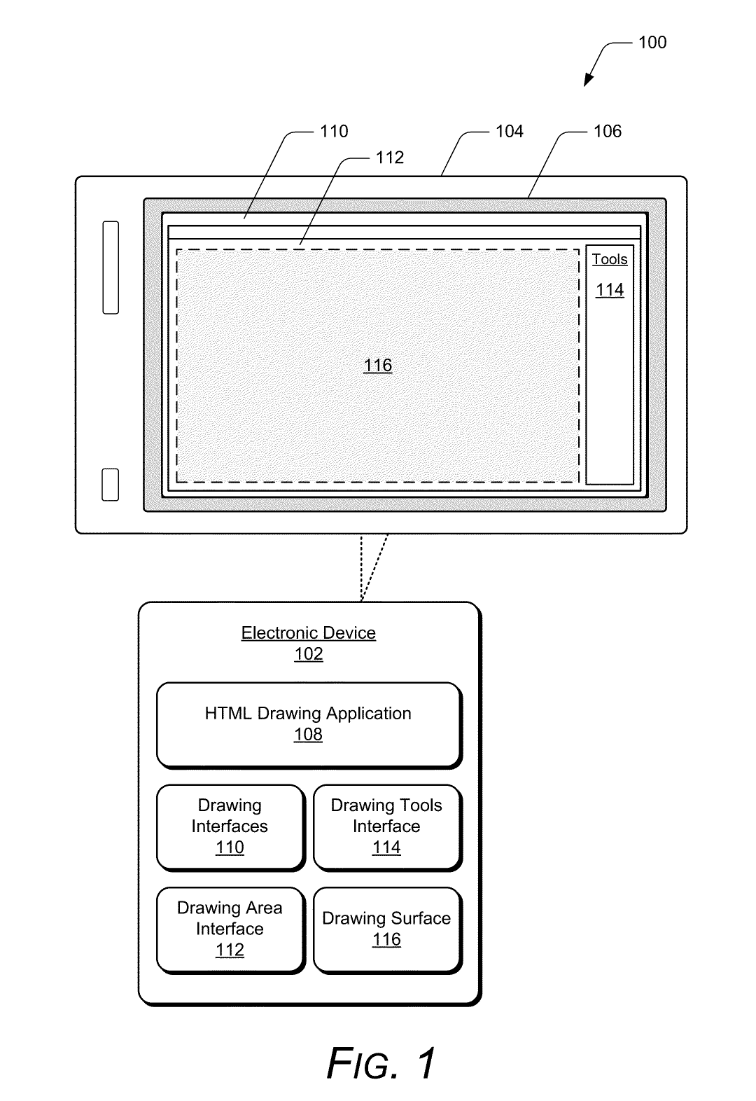

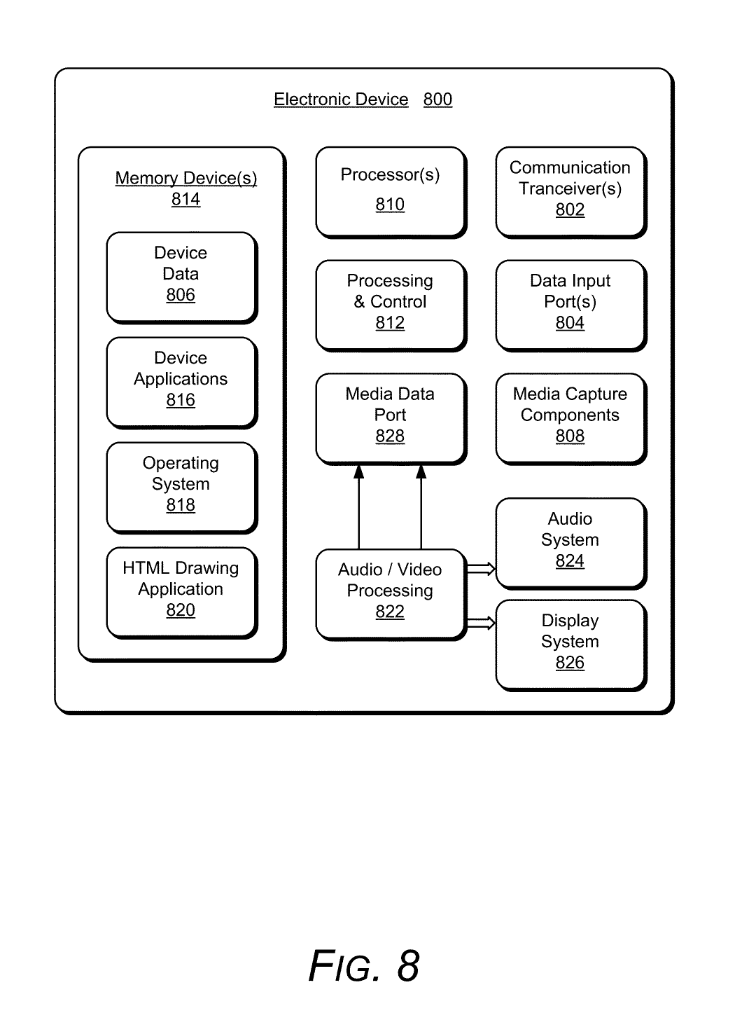

FIG. 1 illustrates an example system 100 in which embodiments of drawing HTML elements can be implemented. The example system 100 includes an electronic device 102, which is shown as a tablet or other portable device 104 having an integrated touch screen display that is implemented as both an integrated display device 106 and an input mechanism. In implementations, various types of computer devices, display devices, and input mechanisms may be used, such as a personal computer having a monitor, a keyboard, and a mouse; a laptop with an integrated display device and keyboard with a touchpad; or a smart phone with a small integrated display device, a telephone keypad, and navigation keys. Electronic device 102 can be implemented with various components, such as one or more processors and memory, as well as with any combination of differing components as further described with reference to the example electronic device shown in FIG. 8.

In embodiments, the electronic device 102 includes an HTML drawing application 108 that can be implemented as computer-executable instructions, such as a software application, and executed by one or more processors to implement the various embodiments of drawing HTML elements described herein. The HTML drawing application is implemented to display drawing interfaces 110 which enables users to create or modify HTML elements, such as DIVs and SPANs. The drawing interfaces can be displayed on the integrated display device 106 of the electronic device, and can include a drawing area interface 112 and a drawing tools interface 114, an example of which is shown displayed on the integrated display device of the tablet device. When a drawing tool is selected from the drawing tools interface 114, a user can draw HTML elements on an HTML page that is displayed in the drawing area interface 112.

In embodiments, the HTML drawing application 108 is configured to overlay an HTML page displayed in the drawing area interface 112 with a drawing surface 116. Although shown in the figure for discussion purposes, the drawing surface 116 is not displayed or viewable to users of the HTML drawing application, and is implemented to receive drawing-input without modifying the underlying HTML page. In embodiments, the HTML drawing application 108 utilizes the HTML5 canvas element as the drawing surface 116. The canvas element is part of HTML5 and allows for dynamic, scriptable rendering of two-dimensional (2D) shapes and bitmap images. Canvas includes a drawing surface defined in HTML code with height and width attributes that allows developers to draw directly onto the canvas via a JavaScript application program interface (API). Unlike typical HTML creation tools, which rely on adding additional elements to the document object model (DOM), the HTML drawing application 108 can provide visual feedback using the canvas element without adding or modifying any content in the DOM structure.

In some embodiments, the HTML drawing application 108 can receive, via the drawing area interface 112 of the HTML drawing application 108, drawing-input to specify a size and a location of an HTML element to be created in an HTML page. The HTML drawing application can then initiate display of visual feedback on the drawing surface 116 that overlays the HTML page in the drawing area interface 112 as the drawing-input is received, and create the HTML element in the HTML page based on the size and the location specified by the drawing-input. For example, the HTML drawing application 108 enables a user to draw a rectangle in the drawing area interface 112 to specify a size and a location of an HTML element to be created in an HTML page. Unlike prior solutions, therefore, users can easily size and place HTML elements using the HTML drawing application 108.

In other embodiments, the HTML drawing application 108 can receive, via the drawing area interface 112, drawing-input to create an HTML element inside an existing HTML element in an HTML page. The HTML drawing application 108 can then provide visual feedback on the drawing surface 116 that overlays the HTML page in the user interface as the drawing-input is received. The HTML drawing application 108 can determine a position of the HTML element relative to the existing HTML element based on the drawing-input, and create the HTML element inside the existing HTML element in the HTML page based on the position of the HTML element relative to the existing HTML element.

In other embodiments, the HTML drawing application 108 can enable, via the drawing area interface 112, display of an HTML page and one or more HTML elements in the HTML page. The HTML drawing application 108 can then receive a selection of an HTML element in the HTML page, and initiate display of visual feedback on the drawing surface 116 that overlays the HTML page to indicate that the selected HTML element is selected. In other embodiments, the HTML drawing application 108 can enable, via the drawing area interface 112, display of an HTML page and an HTML element in the HTML page, and initiate display of visual feedback on the drawing surface 116 that overlays the HTML page to indicate that the HTML element can be edited.

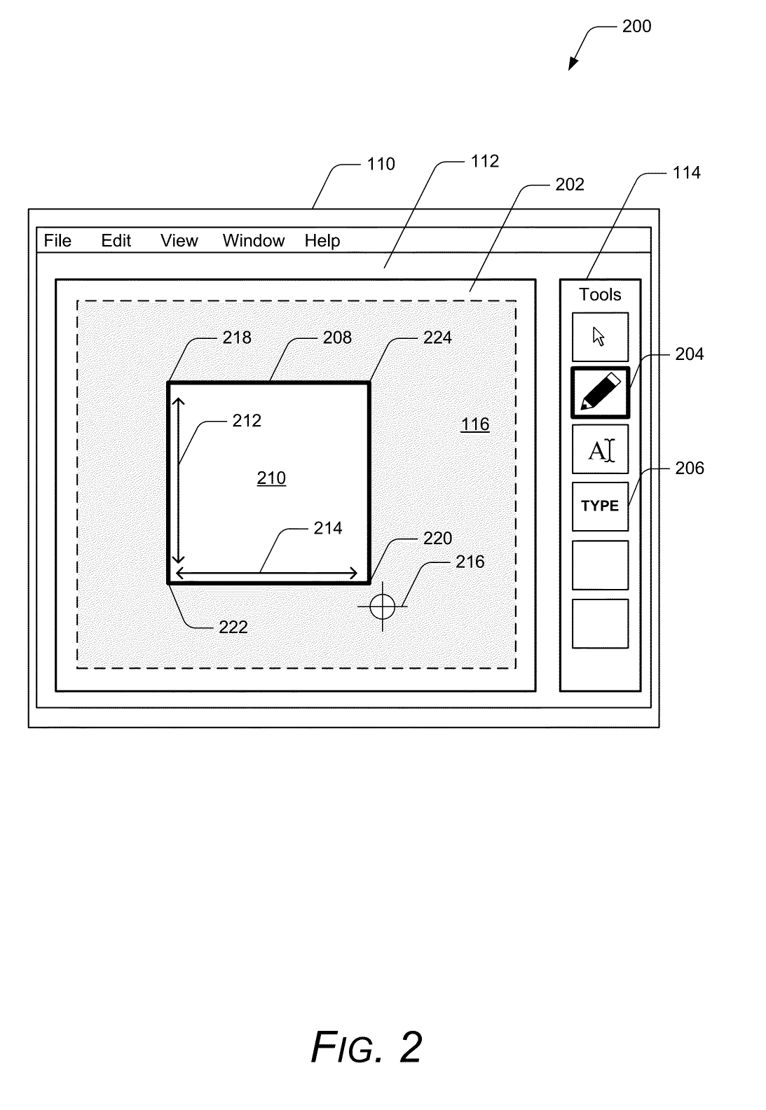

FIG. 2 illustrates an example 200 of drawing interfaces 110 in accordance with one or more embodiments of drawing HTML elements. As noted above, the drawing interfaces 110 can be displayed on the integrated display device 106 of the electronic device, and can include the drawing area interface 112 and the drawing tools interface 114. The HTML drawing application 108 is implemented to enable creation of an HTML page 202 in the drawing area interface 112. In some embodiments, the HTML drawing application 108 automatically creates a new HTML page 202 in the drawing area interface when the HTML drawing application is launched. In other embodiments, the HTML drawing application 108 enables creation of a new HTML page 202 after the HTML drawing application is launched. For example, a user can select a “New HTML Page” command from the file menu of drawing interfaces 110 to create the HTML page 202.

The HTML drawing application 108 is implemented to overlay the HTML page 202 displayed in the drawing area interface 112 with the drawing surface 116. The drawing surface may not be viewable to users of the HTML drawing application because it is clear, and is configured to receive drawing-input and display visual feedback without modifying the underlying HTML page 202. It should be noted that the drawing surface 116 covers the entire HTML page, and that positions on the drawing surface map directly to positions on the HTML page. In embodiments, HTML drawing application 108 utilizes the HTML5 canvas element as the drawing surface 116.

The drawing tools interface 114 includes various drawing tools that enable creation and modification of HTML elements, including a drawing tool 204 and an element type tool 206. The element type tool 206 enables selection of various types of HTML elements (e.g., any HTML element type or tag) that can be created using the HTML drawing application 108, such as DIVs, SPANs, videos, images, sections, articles, and paragraphs, to name just a few. After the type of HTML is selected, the drawing tool 204 may be selected and used to provide drawing-input 208 to specify a size and a location of an HTML element 210 to be created in the HTML page 202.

Drawing-input 208 can be received as a shape, or an outline of the HTML element 210 to be created. In this example, the drawing-input 208 is received as a rectangle drawn on the drawing surface 116 that overlays the HTML page 202 using the drawing tool 204. Alternately, the drawing-input 208 can be received as various other shapes, such as a circle, a rectangle, or any type of free-form drawing-input that outlines the HTML element 210 to be created in the HTML page 202. In this example, the rectangle specifies a size and a location of the HTML element 210 to be created in the HTML page 202. For instance, the drawing-input 208 specifies the size of the HTML element by specifying a height and a width of the HTML element 210 to be equal to a height 212 and a width 214, respectively, of the rectangle. Similarly, the drawing-input 208 specifies the location of the HTML element 210 by specifying the location of the HTML element to be equal to a location of the rectangle drawn on the drawing surface 116 that overlays the HTML page 202.

The HTML drawing application 108 is configured to receive the drawing-input 208 via various different types of input devices. In some embodiments, electronic device 102 enables the drawing-input 208 to be received via a mouse-down, mouse-drag, and mouse-up operation to draw the shape as a rectangle. For example, a user can position a cursor 216 at a position 218 on the drawing surface 116 using a mouse, and press and hold a button on the mouse to generate a mouse-down signal. When the mouse-down signal is received, the HTML drawing application stores position 218 on the drawing surface 116. Using the mouse, the user can then drag the cursor 216 down and to the right to position 220 (while still holding the button on the mouse down) to generate a mouse-drag signal. As described in more detail below, the user can then release the button on the mouse to generate a mouse-up signal to create the HTML element 210 with a size and a location equal to the rectangle of the drawing-input 208.

In other embodiments, the electronic device 102 enables drawing-input 208 to be received via a touch-contact, touch-drag, and end of the touch-contact to draw the shape as a rectangle. For example, when integrated display device 106 is implemented as a touch screen display, the drawing-input 208 is received when a user touches and holds a fingertip (or stylus) at position 218 on the drawing surface 116 to generate a touch-contact signal. When the touch-contact signal is received, the HTML drawing application 108 stores position 218 on the drawing surface 116. The user can then drag the fingertip down and to the right to position 220 to generate a touch-drag signal. As described in more detail below, the user can then release the fingertip from the touch screen display to end the touch-contact signal to create the HTML element 210 with a size and a location equal to the rectangle of the drawing-input 208. It should be noted that the rectangle may also be created using other touch operations, such as a touch-pinch, touch-drag, and touch-up operation. For example, to create the rectangle of the drawing-input 208 using the touch-pinch, touch-drag, or touch-up operation, a user can touch two fingertips inside the rectangle, and then drag one fingertip to a position 222 and drag the other fingertip to a position 224.

As the drawing-input 208 is received, the HTML drawing application 108 is implemented to initiate display of visual feedback on the drawing surface 116 that overlays the HTML page 202 in the drawing area interface 112. The HTML drawing application 108 provides the visual feedback by initiating display of the drawing-input 208 on the drawing surface 116 without altering the underlying HTML page 202. In this example, as the user starts dragging the mouse, fingertip, or stylus from position 218 to position 220, the HTML drawing application 108 provides the visual feedback by drawing the rectangle of the drawing-input 208 that outlines the HTML element to be created on the drawing surface. Note that the visual feedback of the rectangle will increase in height and/or width as the user moves the mouse, fingertip, or stylus. In this example, as the mouse, fingertip, or stylus moves to the right, the visual feedback of the rectangle increases in width. Similarly, as the mouse, fingertip, or stylus moves down, the visual feedback of the rectangle increases in height. Thus, by providing visual feedback, the HTML drawing application enables the user to specify the precise size and location of the HTML element 210 to be created in the HTML page 202.

After the drawing-input 208 is received, the HTML drawing application 108 creates the HTML element 210 in the HTML page 202 based on the size and the location specified by the drawing-input 208. For example, if the type of the HTML element is selected to be an HTML DIV element, then the HTML drawing application creates the HTML DIV element in the code of the HTML page 202 with a size equal to the size of the drawing-input 208 and at a location that is equal to the location of the drawing-input 208. Therefore, the HTML element 210 is placed by the HTML drawing application using absolute positioning. The HTML drawing application 108 creates the HTML element 210 by automatically creating and applying cascading style sheets (CSS) to the HTML element.

In embodiments, the HTML drawing application 108 creates the HTML element 210 responsive to the mouse-up command or end of the touch-contact. For example, after dragging the cursor 216 to the position 220 on the drawing surface 116, the user can release the mouse button to generate the mouse-up command which causes the HTML drawing application to create the HTML element 210 in the HTML page 202. Similarly, after dragging the fingertip to position 220 on the drawing surface 116, the user can release the fingertip to end the touch-contact which causes the HTML drawing application to create the HTML element 210.

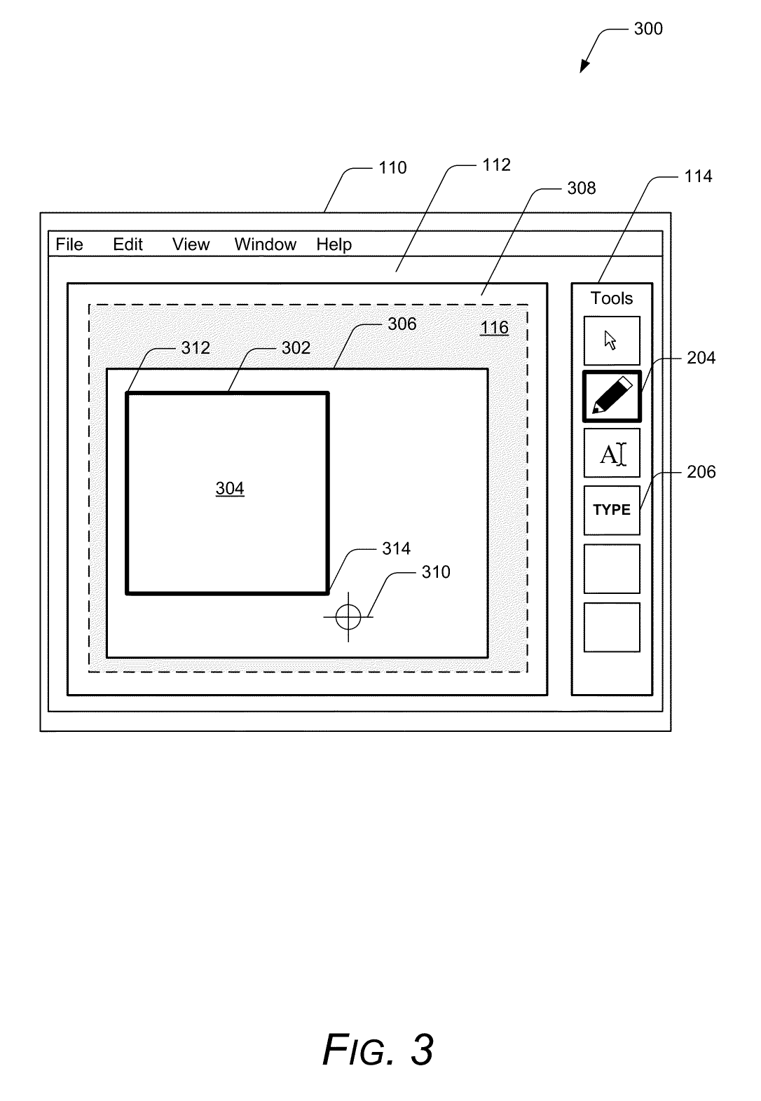

FIG. 3 illustrates an additional example 300 of drawing interfaces 110 in accordance with one or more embodiments of drawing HTML elements. In this example, the HTML drawing application 108 is implemented to receive, via the drawing area interface 112, drawing-input 302 to create an HTML element 304 inside an existing HTML element 306 in an HTML page 308. In some embodiments, the existing HTML element 306 is the HTML element created in example 200 based on drawing-input 208. The drawing-input 302 can be received in a similar manner as described in example 200. For example, the drawing-input 302 can be received via a mouse-down, mouse-drag, and mouse-up operation to move a cursor 310 from a position 312 to a position 314 to draw the shape as a rectangle. Similarly, the drawing-input 302 can be received via a touch-contact, touch-drag, and end of the touch-contact operation from position 312 to position 314 to draw the shape as a rectangle.

Similar to example 200, the HTML drawing application 108 is implemented to provide visual feedback on the drawing surface 116 that overlays the HTML page 308 in the drawing area interface 112 as the drawing-input 302 is received. For example, as the user starts dragging the mouse, fingertip, or stylus from position 312 to position 314, the HTML drawing application 108 provides the visual feedback by drawing the rectangle that outlines the HTML element 304 on the drawing surface 116.

In this example, however, the HTML drawing application 108 is implemented to determine a position of the HTML element 304 relative to the existing HTML element 306 based on the drawing-input. In other words, unlike the HTML element created in example 200, the HTML element 304 to be created has no specified size or location relative to the HTML page 308. Instead, the width, height, and position of the HTML element 304 is specified based on the existing HTML element 306. The HTML drawing application 108 is implemented to create the HTML element 304 inside the existing HTML element 306 in the HTML page 308 based on the position of the HTML element 304 relative to the existing HTML element 306. For example, if a type of the HTML element is selected to be an HTML DIV element, then the HTML drawing application creates the HTML DIV element in the code of the HTML page 308 based on the position of the HTML DIV element relative to the existing HTML element 306. Therefore, unlike example 200 in which the HTML drawing application places the HTML element using absolute positioning, the HTML element in this example 300 is placed by the HTML drawing application using relative positioning and is added to the HTML page 308 as a child of the existing HTML element 306. The HTML drawing application 108 creates the HTML element 304 by automatically creating and applying cascading style sheets (CSS) to the HTML element.

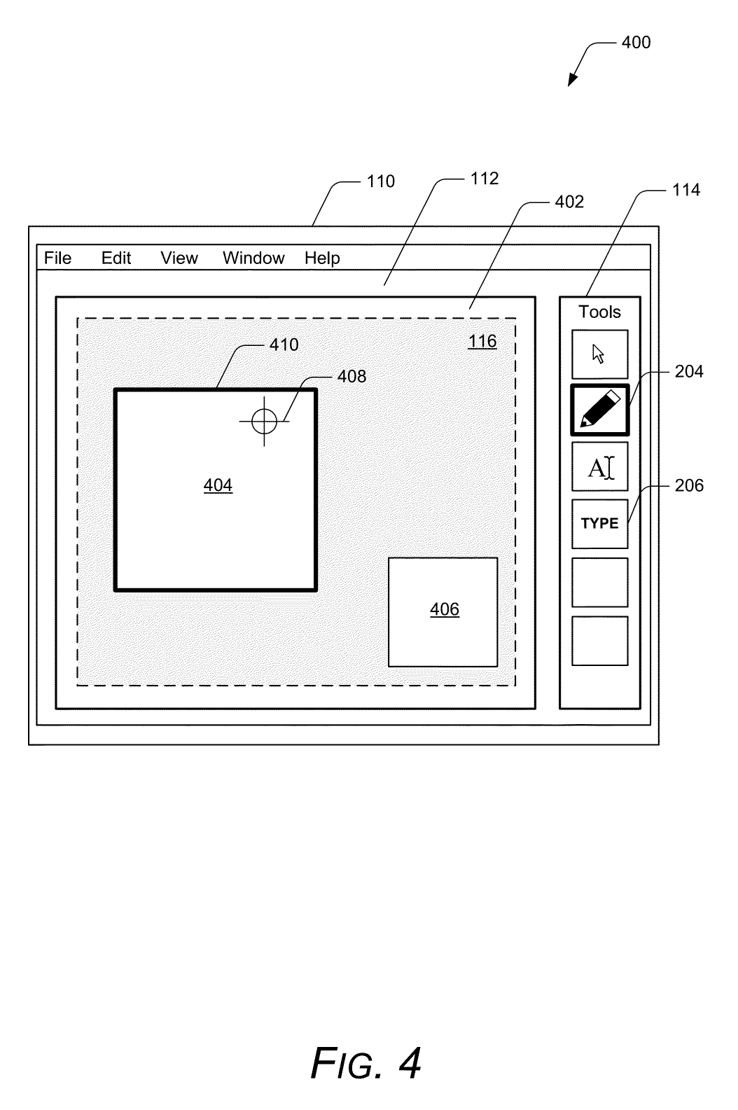

FIG. 4 illustrates an additional example 400 of drawing interfaces 110 in accordance with one or more embodiments of drawing HTML elements. In this example, the HTML drawing application 108 is implemented to enable, via the drawing area interface 112, display of an HTML page 402 and one or more HTML elements, which are illustrated as HTML element 404 and HTML element 406. HTML elements 404 and 406 may have been created in a similar manner as described in examples 200 and 300 above. For example, HTML elements 404 and 406 may have been created via a mouse-down, mouse-drag, and mouse-up operation, or via a touch-contact, touch-drag, and end of the touch-contact operation, as described above.

In embodiments, the HTML drawing application 108 is implemented to receive a selection of an HTML element in the HTML page 402. In this example, the HTML drawing application has received a selection of HTML element 404. The HTML drawing application 108 can receive the selection of the HTML element 404 via various different types of input devices. In some embodiments, electronic device 102 enables the selection of the HTML element 404 to be received via a mouse-click operation on the HTML element 404. For example, a user can position a cursor 408 on an area of the drawing surface 116 that overlays the HTML element 404 using a mouse, and click a button on the mouse to select the HTML element 404. In other embodiments, electronic device 102 enables the selection of the HTML element 404 to be received via a touch operation on the HTML element 404. For example, when integrated display device 106 is implemented as a touch screen display, a user can touch an area of the drawing surface 116 that overlays the HTML element 404 using a fingertip (or stylus) to select the HTML element 404. It is to be noted, however, that the HTML element 404 can be selected in a variety of different manners as well.

In some embodiments, the HTML drawing application 108 is implemented to receive a selection of one or more HTML elements in the HTML page 402 via user input that specifies a selection rectangle. For example, a user can position the cursor 408 on the drawing surface 116 using the mouse, click a button on the mouse, and drag the cursor 408 to specify a selection rectangle on the drawing surface 116. The HTML drawing application 108 is then implemented to select the elements that overlap the selection rectangle. For example, if the selection rectangle overlaps HTML elements 404 and 406, then the HTML drawing application 108 can select both HTML element 404 and HTML element 406.

Responsive to receiving the selection of HTML element 404, the HTML drawing application 108 is implemented to initiate display of visual feedback on the drawing surface 116 that overlays the HTML page 402 to indicate that the selected HTML element 404 is selected. In this example, to provide the visual feedback, the HTML drawing application 108 draws a selection outline 410 on the drawing surface 116 around the selected HTML element 404 to indicate that the selected HTML element is selected. The visual feedback distinguishes the selected HTML element 404 from one or more unselected HTML elements in the HTML page 402, such as unselected HTML element 406. In this example, the selection outline 410 is thicker than a corresponding outline or border around unselected HTML element 406 to distinguish the selected HTML element 404 from the unselected HTML element 406. It is to be noted, however, that various different types of visual feedback may be provided on the drawing surface 116 to indicate that the HTML element is selected. For example, the selection outline 410 may be displayed as a different color, line-type, line-thickness, shaded, and/or as any other type of indication that an HTML element 404 is selected.

Unlike conventional HTML editing applications which modify an HTML element to show that the HTML element is selected, the HTML drawing application 108 is implemented to provide the visual feedback on the drawing surface 116 without altering the underlying HTML element 404. In this example 400 for example, the selection outline 410 is drawn directly onto the drawing surface 116 without modifying any of the HTML content beneath the drawing surface.

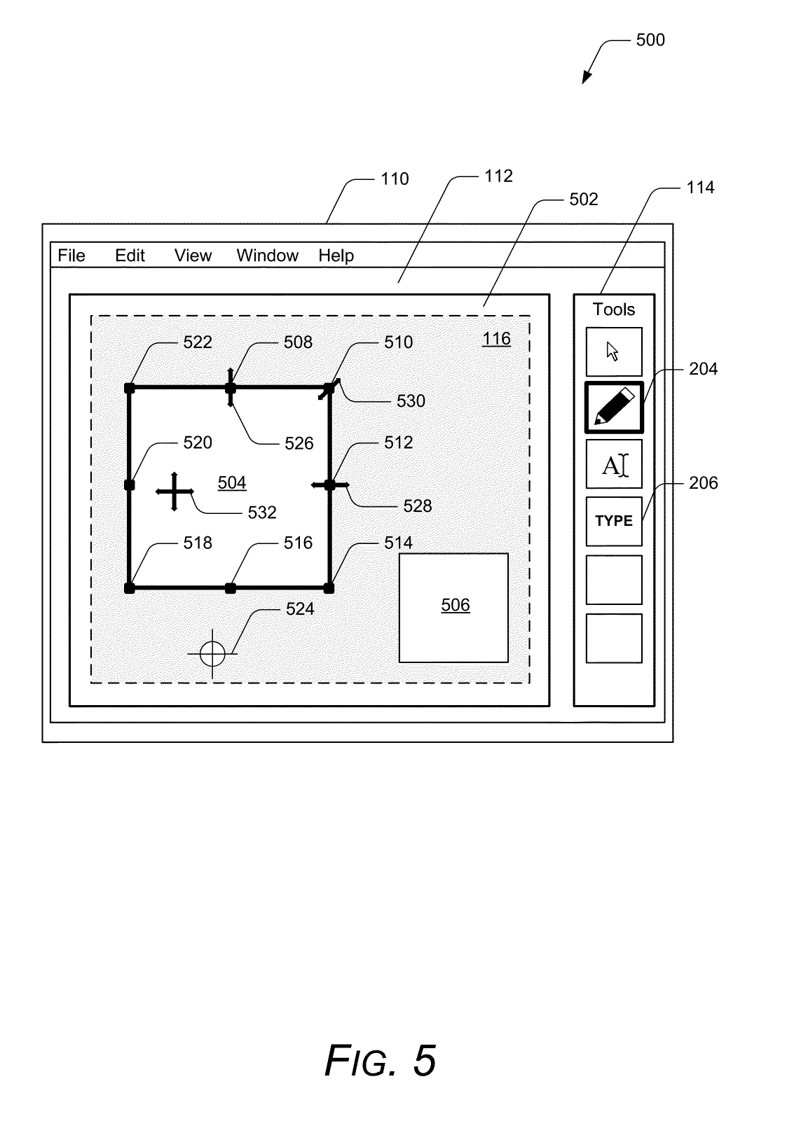

FIG. 5 illustrates an additional example 500 of drawing interfaces 110 in accordance with one or more embodiments of drawing HTML elements. In this example, the HTML drawing application 108 is implemented to enable, via the drawing area interface 112, display of an HTML page 502 and one or more HTML elements, which are illustrated as HTML element 504 and HTML element 506. HTML elements 504 and 506 may have been created in a similar manner as described in examples 200 and 300 above. For example, HTML elements 504 and 506 may have been created via a mouse-down, mouse-drag, and mouse-up operation or via a touch-contact, touch-drag, and end of the touch-contact operation, as described above. Furthermore, in some embodiments the HTML element 504 may have been previously selected, as described in example 400.

In embodiments, the HTML drawing application 108 is implemented to initiate display of visual feedback on the drawing surface 116 that overlays the HTML 502 page to indicate that the HTML element 504 can be edited. In this example, drawing application 108 provides the visual feedback by drawing one or more editing handles 508, 510, 512, 514, 516, 518, 520, and 522 on the drawing surface 116 around a border of the HTML element. The editing handles indicate that the HTML element 504 can be resized or moved. For example, editing handles 508 and 516 indicate that the HTML element 504 can be resized vertically; editing handles 512 and 520 indicate that the HTML element 504 can be resized horizontally; and editing handles 510, 514, 518, and 522 indicate that the HTML element 504 can be resized both vertically and horizontally at the same time.

In an embodiment, the drawing application 108 is implemented to provide visual feedback when an editing handle is selected, such as by drawing a directional arrow on the drawing surface 116 that indicates a direction in which the HTML element 504 can be resized or moved. In this example, an editing handle can be selected by moving a cursor 524, using a mouse, over the editing handle, or by touching the editing handle with a fingertip or stylus. For example, when editing handle 508 or 516 is selected, the HTML drawing application 108 can draw a vertical directional arrow 526 on the drawing surface 116 proximate the location of a selected editing handle to indicate that the HTML element 504 can be resized vertically. Similarly, when editing handle 512 or 520 is selected, the HTML drawing application 108 can draw a horizontal directional arrow 528 on the drawing surface 116 proximate the location of the selected editing handle to indicate that the HTML element 504 can be resized horizontally. Similarly, when editing handle 510, 514, 518, or 522 is selected, the HTML drawing application 108 can draw a diagonal arrow 530 on the drawing surface 116 proximate the location of the selected editing handle to indicate that the HTML element 504 can be resized both vertically and horizontally. In embodiments, when any other section of the HTML element 504 is selected, the HTML drawing application 108 can draw a horizontal and vertical arrow 532 to show that the HTML element 504 can be moved in any direction.

In another embodiment, the drawing application 108 is implemented to provide visual feedback when an editing handle is selected by changing the appearance of the cursor 524 to a directional arrow that indicates a direction in which the HTML element 504 can be resized or moved. For example, when editing handle 508 or 516 is selected, the HTML drawing application 108 can change the appearance of the cursor 524 to the vertical directional arrow 526 to indicate that the HTML element 504 can be resized vertically. Similarly, when editing handle 512 or 520 is selected, the HTML drawing application 108 can change the appearance of the cursor 524 to the horizontal directional arrow 528 to indicate that the HTML element 504 can be resized horizontally. Similarly, when editing handle 510, 514, 518, or 522 is selected, the HTML drawing application 108 can change the appearance of the cursor 524 to the diagonal arrow 530 to indicate that the HTML element 504 can be resized both vertically and horizontally. In embodiments, when any other section of the HTML element 504 is selected, the HTML drawing application 108 can change the appearance of the cursor 524 to the horizontal and vertical arrow 532 to show that the HTML element 504 can be moved in any direction.

In embodiments, the HTML drawing application 108 is implemented to receive input to edit the HTML element 504 via the drawing area interface 112. Various different types of input to edit the HTML element can be received, such as input to edit the HTML element by resizing, moving, scaling, or rotating the HTML element, to name just a few. The HTML drawing application 108 can receive the input to edit the HTML element 504 via various different types of input devices. In some embodiments, electronic device 102 enables the input to be received via a mouse-down, mouse-drag, and mouse-up operation to resize or move the HTML element 504. For example, a user can position the cursor 524 over any of editing handles 508-522 on the drawing surface 116 using a mouse, and press and hold a button on the mouse to generate a mouse-down signal to select the handle. Using the mouse, the user can drag the cursor 524 in any direction to resize the HTML element 504.

For example, if editing handle 508 or 516 is selected, the user can drag cursor 524 up or down to resize the HTML element 504 by increasing or decreasing a height of the HTML element. Similarly, if editing handle 512 or 520 is selected, the user can drag cursor 524 left or right to resize the HTML element 504 by increasing or decreasing a width of the HTML element. Similarly, if editing handle 510, 514, 518, or 522 is selected, the user can drag cursor 524 up, down, left, and/or right to resize the HTML element 504 by increasing or decreasing both the height and the width of the HTML element 504. Alternately, a user can position the cursor 524 on the drawing surface 116 over any other location on the HTML element 504 using a mouse, and press and hold a button on the mouse to generate a mouse-down signal to select the HTML element 504. Using the mouse, the user can then drag the cursor 524 in any direction to move the HTML element 504.

In other embodiments, the electronic device 102 enables the input to be received via a touch-contact, touch-drag, and end of the touch-contact operation to resize or move the HTML element 504. For example, a user can touch and hold a fingertip (or stylus) over any of editing handles 508-522 on the drawing surface 116 to generate a touch-contact signal to select an editing handle. The user can then drag the fingertip (or stylus) in any direction to resize the HTML element 504.

For example, if editing handle 508 or 516 is selected, the user can drag the fingertip (or stylus) up or down to resize the HTML element 504 by increasing or decreasing a height of the HTML element. Similarly, if editing handle 512 or 520 is selected, the user can drag the fingertip (or stylus) left or right to resize the HTML element 504 by increasing or decreasing a width of the HTML element. Similarly, if editing handle 510, 514, 518, or 522 is selected, the user can drag the fingertip (or stylus) up, down, left, and/or right to resize the HTML element 504 by increasing or decreasing both the height and the width of the HTML element. Alternately, a user can touch the drawing surface 116 over any other location on HTML element 504 using the fingertip or the stylus to generate a touch-contact signal to select the HTML element 504. The user can then drag the fingertip (or stylus) in any direction to move the HTML element 504.

As the input to edit the HTML element 504 is received, the HTML drawing application 108 is implemented to initiate display of additional feedback on the drawing surface 116 that overlays the HTML page 502. The HTML drawing application 108 provides the visual feedback without altering the underlying HTML page 502. In this example, when the user selects one of handles 508-522 and starts dragging the mouse, fingertip, or stylus, the HTML drawing application 108 provides the visual feedback by drawing an outline of the HTML element 504 on the drawing surface. Note that the visual feedback of the outline of the HTML element 504 will increase or decrease in height and/or width corresponding to the direction in which the user moves the mouse, fingertip, or stylus. For example, if the handle 512 is selected, and the mouse, fingertip, or stylus moves to the right, the HTML drawing application 108 controls the visual feedback of the outline of HTML element 504 to increase in width. Alternately, if the handle 512 is selected and the mouse, fingertip, or stylus moves to the left, the HTML drawing application 108 controls the visual feedback of the outline of HTML element 504 to decrease in width.

As another example, if an area other than one of the handles of the HTML element 504 is selected, and the mouse, fingertip, or stylus moves to the right, the HTML drawing application 108 controls the visual feedback of the outline of HTML element 504 to move to the right. Alternately, if an area other than one of the handles of the HTML element 504 is selected, and the mouse, fingertip, or stylus moves downwards, the HTML drawing application 108 controls the visual feedback of the outline of HTML element 504 to move downwards. Thus, by providing visual feedback, the HTML drawing application enables the user to specify the precise size and location of the HTML element when editing the HTML element.

After the input to edit the HTML element 504 is received, the HTML drawing application 108 edits the HTML element 504 in the HTML page 502 based on the input. For example, if the input to edit the HTML element 504 is to increase the width of the HTML element, then the HTML drawing application increases the width of the HTML element 504 in the HTML page 502. Similarly, if the input to edit the HTML element 504 is to move the HTML element to the right, then the HTML drawing application moves the HTML element 504 to the right in the HTML page 502. In embodiments, the HTML drawing application 108 edits the HTML element 504 responsive to the mouse-up command or end touch-contact.

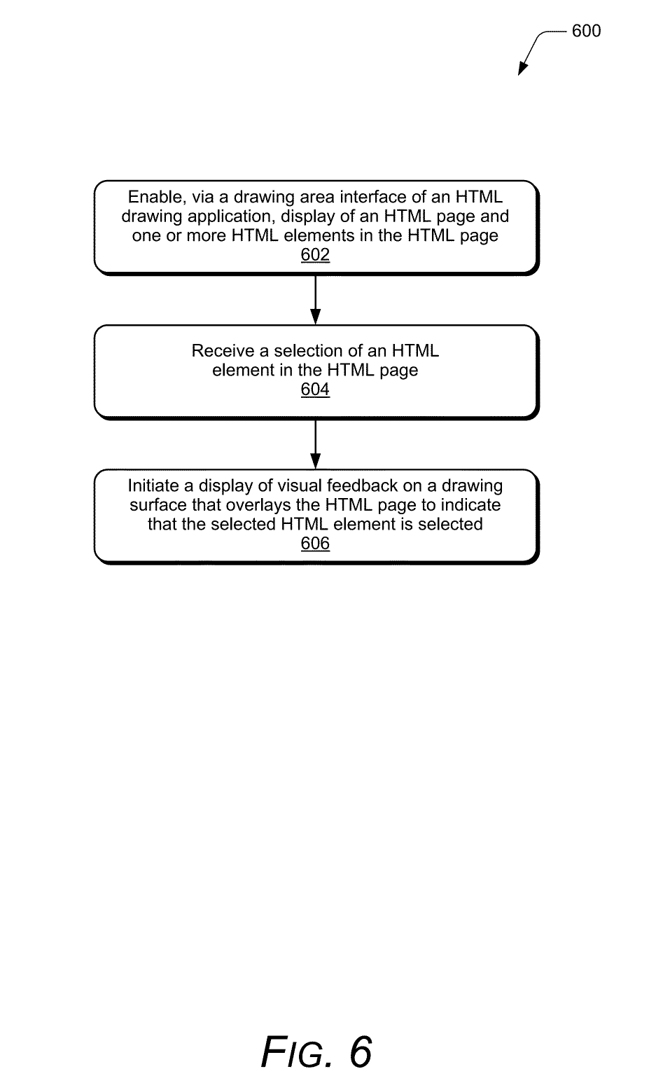

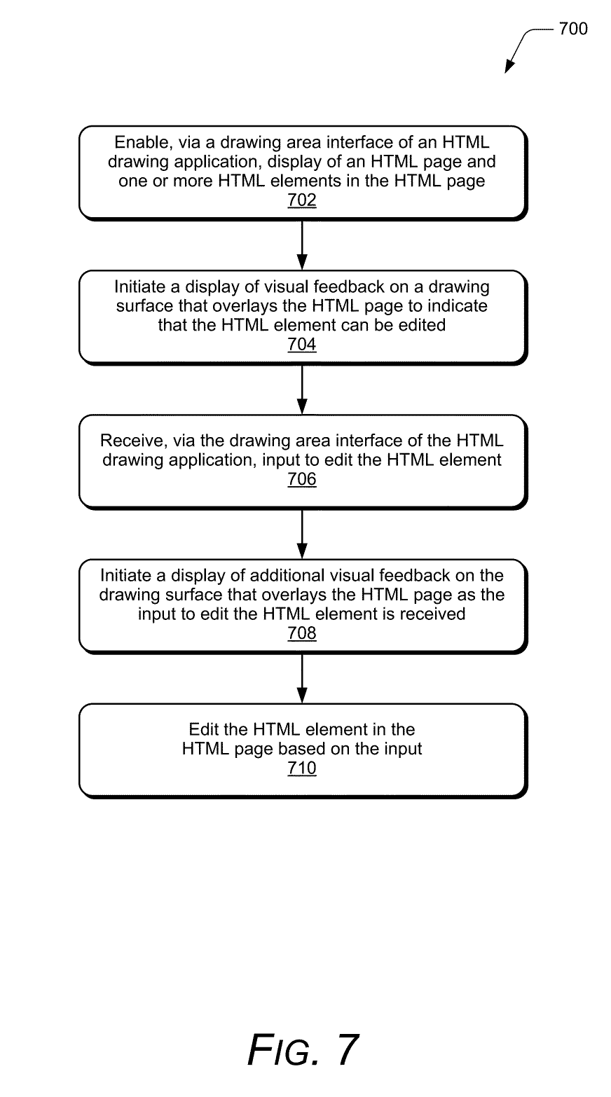

Example methods 600 and 700 are described with reference to respective FIGS. 6 and 7 in accordance with one or more embodiments of drawing HTML elements. Generally, any of the methods, components, and modules described herein can be implemented using software, firmware, hardware (e.g., fixed logic circuitry), manual processing, or any combination thereof. A software implementation represents program code that performs specified tasks when executed by a computer processor, and the program code can be stored in computer-readable storage media devices.

FIG. 6 illustrates example method(s) 600 of drawing HTML elements. The order in which the method blocks are described are not intended to be construed as a limitation, and any number or combination of the described method blocks can be combined in any order to implement a method, or an alternate method.

At block 602, display of an HTML page and one or more HTML elements in the HTML page is enabled via a drawing area interface of an HTML drawing application. For example, the HTML drawing application 108 of the electronic device 102 (FIG. 1) enables display of the HTML page 402 (FIG. 4) in the drawing area interface 112.

At block 604, a selection of an HTML element in the HTML page is received. For example, the HTML drawing application 108 of the electronic device 102 receives a selection of the HTML element 404 in the HTML page 402.

At block 606, visual feedback is initiated for display on a drawing surface that overlays the HTML page to indicate that the selected HTML element is selected. For example, the HTML drawing application 108 of the electronic device 102 initiates visual feedback for display on the drawing surface 116 that overlays the HTML page 402 to indicate that the selected HTML element 404 is selected. The visual feedback distinguishes the selected HTML element from unselected HTML elements in the HTML page, and can include a selection outline on the drawing surface around the selected HTML element to indicate that the selected HTML element is selected. Further, the visual feedback is displayed on the drawing surface without altering the selected HTML element.

FIG. 7 illustrates additional example method(s) 700 of drawing HTML elements. The order in which the method blocks are described are not intended to be construed as a limitation, and any number or combination of the described method blocks can be combined in any order to implement a method, or an alternate method.

At block 702, display of an HTML page and one or more HTML elements in the HTML page is enabled via a drawing area interface of an HTML drawing application. For example, the HTML drawing application 108 of the electronic device 102 (FIG. 1) enables display of the HTML page 502 (FIG. 5) in the drawing area interface 112.

At block 704, visual feedback is initiated for display on a drawing surface that overlays the HTML page to indicate that the HTML element can be edited. For example, the HTML drawing application 108 of the electronic device 102 initiates visual feedback for display on the drawing surface 116 that overlays the HTML page 502 to indicate that the HTML element 504 can be edited. The visual feedback distinguishes the HTML element and is displayed on the drawing surface without altering the HTML element. For example, the visual feedback can include drawing one or more editing handles on the drawing surface around a border of the HTML element to indicate that the HTML element can be resized and/or moved.

At block 706, input to edit the HTML element is received via the drawing area interface of the HTML drawing application. For example, the HTML drawing application 108 of the electronic device 102 receives input to edit the HTML element 504 via the drawing area interface 112. The input to edit the HTML element can include input to resize and/or move the HTML element.

At block 708, additional visual feedback is initiated for display on the drawing surface that overlays the HTML page as the input to edit the HTML element is received. For example, the HTML drawing application 108 of the electronic device 102 initiates additional visual feedback for display on the drawing surface 116 that overlays the HTML page 502 as the input to edit the HTML element 504 is received. The additional visual feedback that is displayed can include the vertical directional arrow 526, the horizontal directional arrow 528, the diagonal arrow 530, or the horizontal and vertical arrow 532 to indicate that the HTML element can be resized and/or moved. Alternately, the appearance of the cursor 524 can be changed to the vertical directional arrow 526, the horizontal directional arrow 528, the diagonal arrow 530, or the horizontal and vertical arrow 532 to indicate that the HTML element can be resized and/or moved.

At block 710, the HTML element in the HTML page is edited based on the input. For example, the HTML drawing application 108 of the electronic device 102 edits the HTML element 504 in the HTML page 502 based on the input.

FIG. 8 illustrates various components of an example electronic device 800 that can be implemented as any device described with reference to any of the previous FIGS. 1-7. The electronic device may be implemented as any one or combination of a fixed or mobile device, in any form of a consumer, computer, portable, user, communication, phone, navigation, gaming, media playback, and/or computer device.

The electronic device 800 includes communication transceivers 802 that enable wired and/or wireless communication of device data 806, such as received data, data that is being received, data scheduled for broadcast, data packets of the data, etc. Example communication transceivers 802 include wireless personal area network (WPAN) radios compliant with various IEEE 802.15 (also referred to as Bluetooth™) standards, wireless local area network (WLAN) radios compliant with any of the various IEEE 802.11 (also referred to as WiFi™) standards, wireless wide area network (WWAN) radios for cellular telephony, wireless metropolitan area network (WMAN) radios compliant with various IEEE 802.15 (also referred to as WiMAX™) standards, and wired local area network (LAN) Ethernet transceivers.

The electronic device 800 may also include one or more data input ports 804 via which any type of data, media content, and/or inputs can be received, such as user-selectable inputs, messages, music, television content, recorded video content, and any other type of audio, video, and/or image data received from any content and/or data source. The data input ports may include USB ports, coaxial cable ports, and other serial or parallel connectors (including internal connectors) for flash memory, DVDs, CDs, and the like. These data input ports may be used to couple the electronic device to components, peripherals, or accessories such as microphones or cameras. Additionally, the electronic device 800 may include media capture components 808, such as an integrated microphone to capture audio and a camera to capture still images and/or video media content.

The electronic device 800 includes one or more processors 810 (e.g., any of microprocessors, controllers, and the like), or a processor and memory system (e.g., implemented in an SoC), which process computer-executable instructions to control operation of the device. Alternatively or in addition, the electronic device can be implemented with any one or combination of software, hardware, firmware, or fixed logic circuitry that is implemented in connection with processing and control circuits, which are generally identified at 812. Although not shown, the electronic device can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

The electronic device 800 also includes one or more memory devices 814 that enable data storage, examples of which include random access memory (RAM), non-volatile memory (e.g., read-only memory (ROM), flash memory, EPROM. EEPROM, etc.), and a disk storage device. A disk storage device may be implemented as any type of magnetic or optical storage device, such as a hard disk drive, a recordable and/or rewriteable disc, any type of a digital versatile disc (DVD), and the like. The electronic device 800 may also include a mass storage media device.

A memory device 814 provides data storage mechanisms to store the device data 806, other types of information and/or data, and various device applications 816 (e.g., software applications). For example, an operating system 818 can be maintained as software instructions within a memory device and executed on the processors 810. The device applications may also include a device manager, such as any form of a control application, software application, signal-processing and control module, code that is native to a particular device, a hardware abstraction layer for a particular device, and so on. In embodiments, the electronic device also includes an HTML drawing application 820 that implements drawing HTML elements. The HTML drawing application 820 is an example of the HTML drawing application 108 at the electronic device 102 shown in FIG. 1.

The electronic device 800 also includes an audio and/or video processing system 822 that generates audio data for an audio system 824 and/or generates display data for a display system 826. The audio system and/or the display system may include any devices that process, display, and/or otherwise render audio, video, display, and/or image data. Display data and audio signals can be communicated to an audio component and/or to a display component via an RF (radio frequency) link, S-video link, HDMI (high-definition multimedia interface), composite video link, component video link, DVI (digital video interface), analog audio connection, or other similar communication link, such as media data port 828. Additionally, the audio system and/or the display system may be external components to the electronic device, or alternatively, are integrated components of the example electronic device.

Although embodiments of drawing HTML elements have been described in language specific to features and/or methods, the subject of the appended claims is not necessarily limited to the specific features or methods described. Rather, the specific features and methods are disclosed as example implementations of drawing HTML elements.

1. A method, comprising:
enabling, via a drawing area interface of an HTML drawing application, display of an HTML page and one or more HTML elements in the HTML page;
receiving a selection of an HTML element in the HTML page; and
initiating display of visual feedback on a drawing surface that overlays the HTML page to indicate that the selected HTML element is selected.

2. The method as recited in claim 1, wherein the drawing surface comprises an HTML5 canvas element.

3. The method as recited in claim 1, wherein initiating display of the visual feedback comprises drawing a selection outline on the drawing surface around the selected HTML element to indicate that the selected HTML element is selected.

4. The method as recited in claim 1, wherein the visual feedback distinguishes the selected HTML element from one or more unselected HTML elements in the HTML page.

5. The method as recited in claim 1, wherein initiating the display of the visual feedback further comprises displaying the visual feedback on the drawing surface without altering the selected HTML element.

6. The method as recited in claim 1, wherein the selected HTML element comprises any HTML element type or tag.

7. A method, comprising:
enabling, via a drawing area interface of an HTML drawing application, display of an HTML page and an HTML element in the HTML page; and
initiating display of visual feedback on a drawing surface that overlays the HTML page to indicate that the HTML element can be edited.

8. The method as recited in claim 7, wherein the drawing surface comprises an HTML5 canvas element.

9. The method as recited in claim 7, wherein initiating the display of the visual feedback comprises drawing one or more editing handles on the drawing surface around a border of the HTML element to indicate that the HTML element can be at least one of resized or moved.

10. The method as recited in claim 9, wherein initiating the display of the visual feedback further comprises one of:
drawing, when an editing handle is selected, one or more directional arrows on the drawing surface to indicate a direction in which the HTML element can be resized or moved; or
changing the appearance of a cursor, that selects the editing handle, to the one or more directional arrows to indicate a direction in which the HTML element can be resized or moved.

11. The method as recited in claim 7, further comprising:
receiving, via the drawing area interface of the HTML drawing application, input to edit the HTML element;
initiating display of additional visual feedback on the drawing surface that overlays the HTML page as the input to edit the HTML element is received; and
editing the HTML element in the HTML page based on the input.

12. The method as recited in claim 11, wherein the input to edit the HTML element comprises input to at least one of resize or move the HTML element.

13. The method as recited in claim 7, wherein the HTML element comprises any HTML element type or tag.

14. The method as recited in claim 7, wherein initiating the display of the visual feedback further comprises displaying the visual feedback on the drawing surface without altering the HTML element.

15. An electronic device, comprising:
a display device configured to display a drawing area interface for editing one or more HTML elements in an HTML page, the drawing area interface including the HTML page and a drawing surface that overlays the HTML page;
a memory and a processor system to implement an HTML drawing application that is configured to:
receive a selection of an HTML element in the HTML page; and
initiate display of visual feedback on the drawing surface that overlays the HTML page to indicate that the selected HTML element is selected.

16. The electronic device as recited in claim 15, wherein the drawing surface comprises an HTML5 canvas element.

17. The electronic device as recited in claim 15, wherein the HTML drawing application is configured to initiate display of the visual feedback by drawing a selection outline on the drawing surface around the selected HTML element to indicate that the selected HTML element is selected.

18. The electronic device as recited in claim 15, wherein the drawing application is configured to initiate display of the visual feedback on the drawing surface without altering the selected HTML element.

19. The electronic device as recited in claim 15, wherein the HTML drawing application is configured to initiate display of the visual feedback on the drawing surface that overlays the HTML page to indicate that the selected HTML element can be edited.

20. The electronic device as recited in claim 19, wherein the HTML drawing application is further configured to:
receive, via the drawing area interface, input to edit the selected HTML element;
initiate display of additional visual feedback on the drawing surface that overlays the HTML page as the input to edit the selected HTML element is received; and
edit the selected HTML element in the HTML page based on the input.
